(19) United States
(12) Patent Application Publication
(10) Pub. No.: US 2021/0288552 A1
(43) Pub. Date: Sep. 16, 2021

(54) Dynamic Rollup for Urban Electric

(71) Applicant: Roberto Carlos Azuri Aguiar, Santo Domingo (DO)

(72) Inventor: Roberto Carlos Azuri Aguiar, Santo Domingo (DO)

(21) Appl. No.: 16/816,569

(22) Filed: Mar. 12, 2020

(51) Int. Cl. H02K 7/18; G06K 9/78

(52) U.S. Cl. CPC H02K 7/1861; G06K 9/78

(57) ABSTRACT

A system for the generation of clean and economical electrical energy, comprising a dynamic rollup system having a plurality of rotors. The rotors are suspended on the road flush with the pavement. The rotors rotate at the speed of the vehicle in circulation over the rollup system. The energy produced by the kinetic energy of rotation of the rotors is stored into accumulators or storages banks and then are transferred to the station. The rotors are embedded with gyroscopic sensors which detect the motion of the tires of the vehicle in circulation and if there is any movement over the rotors other than vehicle tire, the system automatically stops for the safety of the pedestrians. Temperature sensors are installed in each of the rotor in case of over load into the system, so that the signal is cut for the particular rotor and thereby having no effect on the system.

### TECHNICAL FIELD

The present invention relates to field of general engineering, particularly to the field of renewable energy. The present invention in particular relates to the generation of electricity by the vehicular movement, specifically by the rotation of the vehicle tires contacting with road pavement.

### BACKGROUND OF THE INVENTION

The increasing movement of human beings from the rural to urban areas has led to an increasing consumption of the major sources of the planet. An estimate shows that around 54 percent of the world population lives in cities, so a major concern arises that in cities a man consumes more energy than in rural areas. So this paradigm of generation of energy most likely electrical energy needs to be changed and some efficient ways required to be developed. This transition implies an increase in the demand of electrical energy, especially in the urban environments where mobility is greater, leading to the need to increase the levels of electrical energy production. If production continues to be from fossil fuels, electric mobility will not be sustainable. To change the paradigm and have a really sustainable concept of mobility with the use of electric vehicles, electrical energy production must be done using renewable energy sources.

With the present energetic paradigm, most electrical energy production uses fossil fuel combustion, which makes economies dependent on fuel costs. This is also leading to irreversible environmental damage, with growing levels of CO2 emissions. According to International Energy Agency (IEA, 2016a), in 2014, globally, more than 80% of energy production came from fossil fuels. Urgent action is required to change the paradigm of electrical energy generation as, presently, energy is mostly produced outside cities, consuming non-renewable resources and inducing energy losses between the point of production and the point of consumption. Energy production must be based on renewable resources, decentralized, happen near to the point of consumption and, preferably, when it is needed.

However, renewable energy sources are not fully effective, as they do not allow electrical energy to be produced when it is needed, but only when the resources are available. These energy sources do not allow electrical energy to be produced where this is needed either, but only where the resources are available and the installation of the technologies is feasible and viable. New ways of generating electric energy are needed, especially to generate energy when and where consumption is required.

Within cities, there are roads that carry vehicles, the main option for mobility. Vehicles consume energy to work their engines and release energy in different ways, by way of different components. Part of the energy released by vehicles goes into the road pavement. 15% to 21% of the energy is transferred to the vehicle's wheels. As vehicles abound in all cities in developed countries, this means that a considerable amount of energy is transferred to road pavements without ever being used. So, road pavements represent a considerable source of energy ready to be harvested and converted into useful forms of energy, such as electrical energy, at the same time reducing the need to “import” energy from distant places.

A major thing we might have noticed about the so called Dynamos is that it has been widely used by cyclist for years and also generates electricity, cyclist have been able to circulate at night on the road with a minimal lightning. Actually, these dynamos used in bicycles are alternators, since they consist of a magnet, integral to the axis of rotation and a static coil without delgas or brushes that rectifies the electric current. The produced electric current is alternating and not continuous, although traditionally they have been called dynamos. On the traditional dynamos, or bottles, the end of the axis of the dynamo carries a head that is supported at will on the tire of one of the wheels, so that when turning the wheel, it allows turning the dynamo as well. The system is quite rudimentary and produces an appreciable friction that forces you to pedal hard. Due to this situation, this type of dynamos has been replaced by other models without friction, like the hub dynamo or ear one. In addition, the appearance of new lighting methods with LED lamps with better batteries, with great power and autonomy, has reduced the use of these dynamos in general.

A concept of friction generally originates when talking about the vehicle tire and the road. A number of research studies have been done on the generation of the electricity by the friction between the tires of a vehicle when moving or accelerating on a ground or road. A study shows that around 10-15 percent of the vehicle's fuel is wasted during said friction of tires and ground. This energy or fuel can be regenerated or renewed by the generation of electricity.

Another concept is the kinetic energy of the vehicle tires rolling over the pavement. The kinetic energy is the energy associated to the bodies when in motion and depends on the mass and speed of the body. The Kinetic Energy, is measured in joules (J), mass, m is measured in kilograms (kg) and velocity (v), in meters/second (m/s). This type of energy can be regenerated naturally only with the movement of the tires. The movement produced by the speed of the bodies in circulation creates a process of kinetic energy. The more movement in the rotors, the more energy is produced, making the most of the vehicular movement to generate clean energy and without any contamination for our planet.

This process of movement energy was developed in a very low scale only used in bicycle to generate a personal energy, but considering the development in technology and the need to keep our planet alive, we are wasting almost 90% of the energy movement. The main engine to generate this dynamic energy is the tires. A number of research studies have been conducted over the regeneration of electrical energy from the friction between the vehicle tires and the ground and the generation of the electrical current within the tires of a moving vehicle.

A relevant art EP' 40921 discloses an energy converter (1) and a system for generating electrical energy in a rolling wheel of a vehicle, wherein an electric generator, comprising a rotor (16) and a stator, is combined with a lever element (5), wherein the lever element (5) has an axis of rotation (6) and is configured for such an arrangement in a wheel for a vehicle that detects a deformation of the tread toward the central axis (10) of the wheel by the lever element (5) and in a rotational movement of the axis of rotation (6) is converted into a pump rotation direction. In this case, the lever element (5) and the electric generator are arranged and configured such that the rotational movement of the rotation axis (6) generated by the lever element (5) in pumping direction of rotation transmitted to the rotor (16) of the electric generator and the electric generator in electrical energy is converted. However it is clear that there is an extra load on the vehicle which eventually leads to the consumption of more fuel although there is generation of energy in the rolling wheel.

The limitations of the existing technology to convert the unused or waste energy from the movement of the rolling vehicles over the ground or pavement, thereby to generate less harmful toxic gases which are generated at an alarming rate over the globe are all solved by a solution provided by the present invention.

### SUMMARY OF THE INVENTION

The present invention relates to the generation of electrical energy by the movement of the vehicle tires over a road. The invention specifically deals with the conversion of the rotational kinetic energy or mechanical energy from the tires of the moving vehicle into the electrical energy. The system can also be termed as electro-mechanical system.

In one of the preferred embodiment of the invention a dynamic rollup for urban electric is provided which is embedded on the road with a pavement. The rollup comprises a number of rotors so that when the tires of the vehicle accelerating or moving on a road contact with the rotors which are suspended produce electrical energy. The energy produced is stored in accumulators installed by the side of the road and then transferred to storage centers for distribution.

The rotor system has an automatic stop protection in case of contact with the human foot, which immediately stops its rotors. For personal safety of the person that circulates above the device and also for an animal that tries to do it. The rotors are provided with gyroscopic sensors to detect the motion of the tire of the moving vehicle. The sensors are embedded in each of the rotors in order to recognize the line drawings of the tires, when any other drawings other than that of the tire of a moving vehicle sets print over the rotor, the gyroscopic sensor sends signal to automatically stop the rotation or circulation. This safety is provided in case of any accident or if avenues are used for a specific event or marathon. The gyroscopic sensors are installed in each rotor to make the turns more efficient, always taking into account the reading of the assigned objects.

The rotors rotate at the speed of the moving vehicle and are designed to rotate up to 450 km without causing any problem to its magnetic field or electric generator. The capacity of the system in ton is about 20,000 tons per dimension by rotors combined by a suspension of flexible springs of impact distributing its load on its four points of couplings in the surface.

The system is built in to the road thus does not create clogging of residues or accumulations of water in the event of a flood or rainfall. Any kind of natural phenomenon does not affect the operation of the system because it is connected to the sewer system of each street or avenue, thereby using their deposits in dehumidifiers for collection of water and taking directly to drain.

Another embodiment states that the rollups are made of high strength and light weight material such as carbon fibre. The system is coated with a titanium coating in aerospace degree to support the speed in the turns produced by the tires of each vehicle. The rotors have the capacity to withstand a sudden twisting motion combining speed per second that can produce this movement without causing any damage in the reading system provided by the sensors.

Another embodiment of the present invention states that the dynamic rollup system of urban electric is an autonomous device that works in a way of only having contact with the tires of the vehicles in circulation; the tires exert a movement in their rotors thereby producing a clean energy. The rotors create a magnetic field producing electrical current through the movement and this energy is transferred to banks of storage or batteries. Accumulators are the storage center for energy produced by vehicles, stored in batteries and then distributed to each home or office.

The present further states that the rotors have a temperature sensor or timer to measure the efficiency of their energy production. In case of an overload in the system, a signal is sent to deactivate the equipment thereby not affecting the production. A technical personnel responds to the signal and in persons reviews the system, both the rotors as of the centre. Each power station is linked to a monitoring center with a communication via GPS. The GPS is installed in one of the sections of the rotors that can be identified by a particular zone, so that one can have a control of the electrical energy produced in the particular zone.

### BRIEF DESCRIPTION OF THE DRAWINGS

The embodiments herein will be better understood in the detailed description with reference to the drawings which are as follows:

FIG. 1 illustrates dynamic rollup installed in prostrate on the road flush with the pavement.

FIG. 2 illustrates movement of the rotors as the vehicle moves over the rollup.

FIG. 3 illustrates drawings of tires of the moving vehicles.

### DETAILED DESCRIPTION OF THE INVENTION

The embodiments herein and the various features and advantageous details thereof are explained more fully with reference to the non-limiting embodiments that are illustrated in the following detailed description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims. The terms like can be, shall be, could be, and other related terms herein disclosed in the foregoing and later parts of the specification in any means do not limit or alter the scope of the present invention. The terms are provided just for the mere understanding of the main invention and its embodiments.

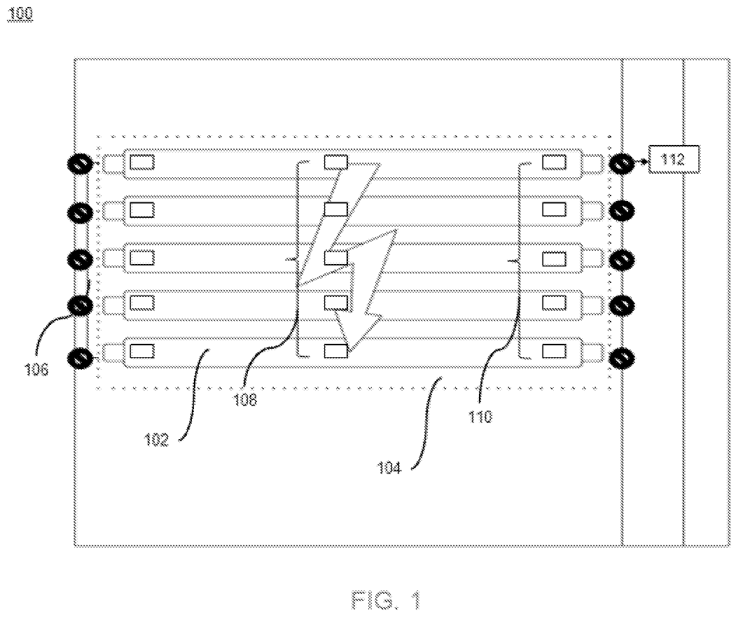

FIG. 1 illustrates dynamic rollup (100) installed on the road flush with the pavement (104). A number of rotors (102) are installed and are suspended within the pavement. The dynamic rollup urban electric technology is built to collect all the energy from the movement of the vehicles on the streets, roads and the like. The energy collected is deposited in an accumulator or battery to be transferred in a clean and economic means. The dynamic rollup is a system of generation and operation of electricity through suspended rotors (102) that when make contact with the tires of a moving vehicle produce energy by the rotational kinetic energy. Dynamic rollup urban electric is a name derived from the technical fact that energy can be extracted from the rollup or rotational rotor installed on the roads in urban or busy roads where movement of vehicles are more. The dynamic rollup (100) urban electric is a system of rotors (102) that rotate up to the speed of 450 km without causing any problem in its magnetic fields or electric generator. The rotor system can support capacity of around 20,000 cubic ton per dimension by rotors, which is combined by a suspension of flexible springs of impact distributing its load in its four points of couplings in the surface. The installation of the rollup on the road flush with the pavement (104) does not hinder the transit because the rotors are in prostrate on the road flush with the pavement.

The rollup or rotor system (100) is built in and does not create clogging of residues or accumulation of water in the event of a flood or recurrent rainfall in active cyclonic season. Therefore natural phenomenon do not represent any problem in the operation of the rotor system because they are connected to the sewer system of each street or avenue, using their deposits in dehumidifiers for collection of water and taking directly to drain.

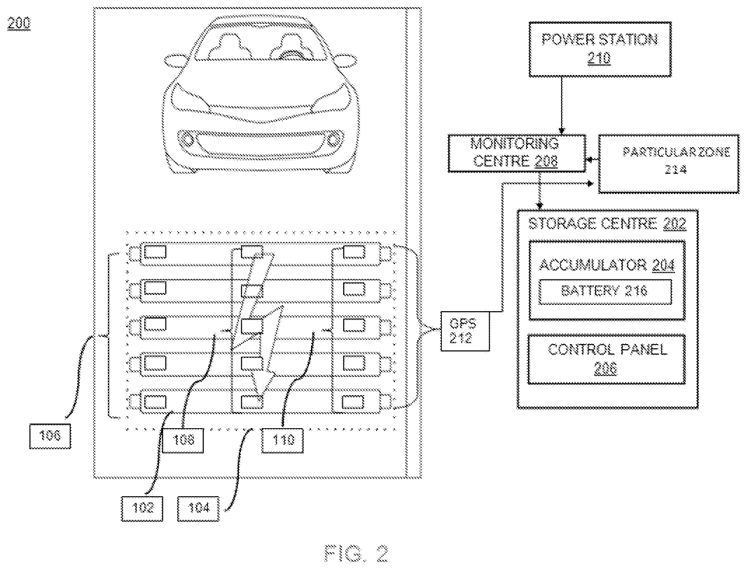

From FIG. 2 there can been seen the movement of the rotors (102) as the vehicle moves over the rotor system. The installation of the system (100) is a base built into the pavement (104) distributing the load of each tire and supporting the multiplied speed torque of each vehicle in circulation. The rollup or rotors are made of lightweight materials such as carbon fibre and resistant at the same time. A coating of titanium is provided in aerospace degree to support the speed in turns produced by the tires of each vehicle. The rotors are created to withstand a speed limit of 450 km, which is extremely difficult for a land vehicle to obtain such an exaggerated speed limit. Each of the rotors has the capacity to withstand sudden twisting motion, combining speed per second that can produce this movement, without causing damage to a reading system of each of the rotor. A maximum speed is assigned because there are very few vehicles that can reach to a high speed to some extent like racing cars and the like, and each speed limit is set by the state or country where rollup system is to be installed.

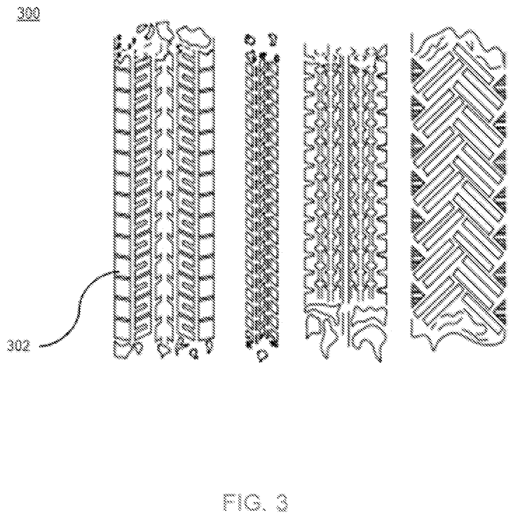

FIG. 3 illustrates the drawings of the tires (106) of the vehicle accelerating on the roads. The rotor system has an automatic stop protection in case of contact with the human foot, which immediately stops its rotors. It is for the personal safety of the pedestrians circulating above the rotor system. A gyroscopic motion sensor (not shown) is installed in each of the rotors (102), the sensor stops automatically if it does not recognizes the drawings of the tire of the vehicle in circulation. This safety is proposed in case of an accident or if the avenues are used for a specific event or a marathon. The gyroscopic sensors are installed in each rotor to make the turns more efficient, always taking into account the reading of the assigned objects.

The dynamic rollup is an urban electric is an autonomous system that works in a way of only having the contact with the tires of the vehicles in circulation; they exert a movement in their rotors (102) producing clean energy. The ECO energy cities have the autonomy as being a self-sufficient place with the help of any conventional equipment. The rotors create a magnetic field producing electric current through the movement and this energy is transferred to the banks of storage or batteries. Accumulators are the storage centre for energy produced by vehicles, stored in batteries and then distributed to each home or office. Each center has a control panel to get readings of the rotors or devices and see their efficiency in their operation.

The rotors have a temperature timer to measure the efficiency of the efficiency of their energy production. In case of an overload in the system a signal will be sent to deactivate the equipment and will not affect the production. By means of this signal, technical personnel will be sent to review the system, both of the rotors as of the center. Each power station will be linked to the monitoring center with a communication via GPS. The GPS will be installed in one of the sections of the rotors that will be identified by your zone, so that you have control of your energy production.

The classification of the components or system used in the generation of the electrical energy from the rollup system are temperature control system to measure the temperature as already stated earlier, the GPS system, a production EM control, Vehicle counter, temperature control rotors and their magnetic couplings, energy banks or batteries, ports like input and output, zone (location-energy distribution), and area technical team. All these system and components are necessary for an effective function of the rollup system and for the production of clean electrical energy.

The dynamic rollup system is a revolutionary ecological system and will serve a great benefit to the society and humanity in large. The ecological technology has a good acceptance, for its operation and behavior in the planet since we know many of them. Kinetic energy is the solution for countries that are affected by atmospheric femmes or the increase of fossil fuels. An ECO energy solution is the DYNAMIC ROLL UP URBAN ELECTRIC, revolutionary and friendly for all types of environment, making a decrease of carbon monoxide that has intoxicated the planet. In addition to this, it allows to prolong the life of our ecosystem. This energy is totally cheap and its motorization is our vehicular transport, reducing the conventional electric rate by up to 60%. Our humanity needs economic and effective solutions to operate, since we have a silent enemy that is global warming. We reduce greenhouse gases without affecting the energy capacity of any of our homes. Guaranteeing stability and profitability for each member of our society. We have always paid traffic taxes through registers, and this is the time to get the second benefit to the urban circulation, producing our own electricity, only with the movement of our city that maintains a high traffic in almost all its avenues and highways. We will have energy to supply our daily routine from day to day, without being affected for an instant.

The biggest benefit of this device is that when there are atmospheric phenomena such as cyclones or hurricanes and we run out of energy. This is where the DYNAMIC ROLL UP URBAN ELECTRIC comes in, solving this great problem. We always suffer the negative effects after the storm because of the problem of electricity and the time of repair of traditional electrical services. This equipment is self-sufficient and does not need any kind of fuel, nor the conventional cabrador or the structure of electric pole. Since its installation is embedded in the pavement and would not affect its electrical production. The wind or the fall of trees is not a problem, because we will always be installed flush with the pavement.

One of the main benefits is the rate of return for society, which represents an increase of 30% to 40% of the unemployment sector, through the different areas offered by the project. Within the areas offered by the project is the installation of the DYNAMIC ROLL UP URBAN ELECTRIC, jobs will be available for both sexes and no matter the profession of the person who applies everything will be governed by training and supervision of high level. The energy sector is very broad and we will have room for people who do not have a decent job.

The big projects bring very good opportunities for the country that adopts this new energy technology. Other benefits to society include infrastructure programs and urban planning among others. We will guarantee employment by the installed operations centers that require the project, to offer a quality service. A constant maintenance that will have the equipment. Brigades will be assigned to perform routine inspections to verify operation and ensure energy efficiency. With the innovation of this technology we will create more sources of jobs to reduce poverty and stabilize the lifestyle of each of the employees of the project. The major departments or phases for the initial development and functioning testing are held by staff training where they work in testing in areas, second one is installation and operation and the third one is monitoring and maintenance.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms mentioned.

1. A dynamic rollup urban electric system for electricity generation, the system comprising:
a dynamic rollup having a plurality of rotors, wherein a gyroscopic motion sensor is located on each rotor to record a momentum generated by a vehicle passing over the dynamic rollup;
a sensor, wherein the sensor is located on the plurality of rotors and is configured to provide a stop signal when an object other than a vehicle passes over the plurality of rotors;
wherein each gyroscopic motion sensor is configured to read and/or recognize a speed, a type and a tire during a movement of the vehicle;
wherein said plurality of rotors are suspended and are in prostrate on a road flush with a pavement;
an electrical current is generated as the plurality of rotors within the pavement come into contact with the tires of the moving vehicle;
wherein the dynamic rollup is a light weight and resistant material with a coating, to support the speed in the turns produced by the tires of each moving vehicle; and
wherein the plurality of rotors create a magnetic field through movement thereby producing electric current.

2. The system as claimed in claim 1, wherein the rollups are made of carbon fibre and coated with titanium.

3. The system as claimed in claim 1, wherein the electric current produced is transferred to banks of storage.

4. The system as claimed in claim 1, wherein the rotors can bear more than 20,000 cubic tons per dimension by rotors.

5. The system as claimed in claim 1, wherein the system comprises a suspension of flexible springs of impact distributing associated loads in associated four points of couplings in the surface.

6. The system as claimed in claim 1, wherein the system installation is a base built into the pavement distributing the load of each tire and supporting the multiplied speed torque of each vehicle in circulation.

7. The system as claimed in claim 1, wherein the rotors are manufactured to withstand a speed limit of 450 km.

8. The system as claimed in claim 1, wherein the electrical energy produced is transferred to accumulators to be stored in batteries and then distributed to each home or office.

9. The system as claimed in claim 8, wherein the accumulators are storage centers, wherein each storage center has a control panel to obtain readings of the devices and see the efficiency during operation.

10. The system as claimed in claim 1, wherein a temperature sensor or timer is installed to measure an efficiency of the electrical energy production.

11. The system as claimed in claim 10, wherein the temperature sensor sends a signal to deactivate the equipment in case of overload in the system.

12. The system as claimed in claim 1, wherein the electrical energy produced is transferred to specified power stations.

13. The system as claimed in claim 12, wherein each power station is linked to a monitoring center with a communication via GPS, wherein the GPS is installed in one of the sections of the rotors that is identified by a particular zone in order to have control of the electrical energy produced in the particular zone.
